(19) United States
(12) Patent Application Publication
(10) Pub. No.: US 2018/0121503 A1
(43) Pub. Date: May 3, 2018

(54) SYSTEMS AND METHODS FOR VIEWING AND ACCESSING DATA USING TAGGING

(71) Applicant: Atavium, Inc., Plymouth, MN (US)

(72) Inventors: Mark A. Bakke, Maple Grove, MN (US); Marc David Olin, Edina, MN (US)

(21) Appl. No.: 15/795,961

(22) Filed: Oct. 27, 2017

Related U.S. Application Data
(60) Provisional application No. 62/414,057, filed on Oct. 28, 2016.

(51) Int. Cl. G06F 17/30

(52) U.S. Cl. CPC G06F 17/30451; G06F 17/30327

(57) ABSTRACT

Systems and methods for viewing, accessing, and monitoring data stored in a data storage system. Tags, metadata, and/or other attributes of data stored in a storage system may be used to define and create particular views of relevant data. In particular, a membership specification may provide inclusion and exclusion directives for determining which files and objects in the storage system to include in the view. A structure specification may provide a structure for organizing and presenting the files and objects in the view. Systems and methods described herein may allow a user to easily identify and view particularly relevant data from, for example, a large storage system storing data form hundreds of files systems. Moreover, the systems and methods described herein may allow for tracking and/or monitoring of particular data attributes.

### CROSS-REFERENCE TO RELATED APPLICATIONS

This application claims priority to U.S. Provisional Application No. 62/414,057, entitled Tag Views, and filed Oct. 28, 2016, the content of which is hereby incorporated by reference herein in its entirety.

### FIELD OF THE INVENTION

The present disclosure relates to data handling and management. Particularly, the present disclosure relates to systems and methods for viewing, accessing, and monitoring data. More particularly, the present disclosure relates to systems and methods for viewing, accessing, and monitoring data by constructing tag-based views of the data.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Data storage systems are often used to store large quantities of data, including different types of data created by different users, groups, programs, and/or applications. The data may be stored in different file systems within the storage system, and may be subject to different directories. Different users or groups may often access, use, or monitor data in the storage system for a different purposes. Given the quantity of data in the storage system and the different directories and file systems, it can be difficult or cumbersome to locate or access particular files or objects. Moreover, where responsibilities, such as data retention and destruction responsibilities, change hands, it can be difficult to maintain consistency and to efficiently monitor data in the storage system. Additionally, it may be difficult to access data created using particular programs, applications, or protocols using different or more updated programs, applications, or protocols. Accordingly, there is a need in the art for systems and methods for data handling. Particularly, there is a need in the art for systems and methods for easily and efficiently viewing, accessing, and monitoring variable data stored in a data storage system.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a view request for viewing a subset of data stored on a data storage system. The view may include a membership specification defining a subset of data to be included in the view, and a structure specification defining a structure by which the view is to be provided. In some embodiments, the membership specification may include an inclusion directive defining data to be included in the view. The structure may include a hierarchical structure in some embodiments. Moreover, the membership may include an exclusion directive defining data to be excluded from the view. In some embodiments, the data stored on the data storage system may be associated with a plurality of tags, and the inclusion directive may include a tag associated with the subset of data. The exclusion directive may additionally include a tag associated with the subset of data. In some embodiments, the inclusion directive may additionally include a tag scope limiting the subset of data. In some embodiments, the data stored on the data storage system may include metadata, and the inclusion directive may include a metadata attribute associated with the subset of data.

The present disclosure, in one or more embodiments, additionally relates to a method of providing a data view. The method may include receiving view request for a subset of data in a data storage system. The view request may include a membership specification defining the subset of data to be included in the view and a structure specification defining a structure by which the view is to be provided. The method may additionally include identifying the subset of data by comparing the membership specification to data in the data storage system, identifying the structure of the view, organizing the subset of data in accordance with the structure to construct the view such that the view is mapped to the data storage system, and presenting the view. In some embodiments, the membership specification may include an inclusion directive defining data to be included in the view, and an exclusion directive defining data to be excluded from the view. The data stored on the data storage system may be associated with a plurality of tags, and the inclusion directive may include a tag associated with the subset of data. The exclusion directive may additionally include a tag associated with the subset of data. The inclusion directive may additionally include a tag scope limiting the subset of data. The method may additionally include updating the view when changes are made to the subset of data. In some embodiments, at least one statistic may be maintained for the tag associated with the subset of data, and presenting the view may include presenting the statistic.

The present disclosure, in one or more embodiments, additionally relates to a data handling system. The data handling system may include a data storage device storing data as non-transitory computer readable media, a membership determining layer for determining a subset of the data identified in a view request, a structure determining layer for determining an organization structure for the subset of data, as identified in the view request, a translation layer for mapping the view to the subset of the data, and a presentation layer for presenting the view of the subset of the data according to the structure. In some embodiments, the data storage device may store a plurality of tags associated with the data, and the subset of the data may be defined by one or more tags. The data handling system may additionally have a statistics engine tracking a statistic for at least one of the one or more tags defining the subset of data. The statistic may include at least one of storage space used, growth rate of storage, I/O operations, objects, I/O operations per second, and storage space used per day.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a conceptual diagram of a data tag view of the present disclosure, according to one or more embodiments.

FIG. 2 is a diagram of a process of the present disclosure, according to one or more embodiments.

FIG. 3 is a diagram of a system of the present disclosure, according to one or more embodiments.

FIG. 4 is a flow diagram of a method of creating a data tag view of the present disclosure, according to one or more embodiments.

### DETAILED DESCRIPTION

The present disclosure relates to novel and advantageous systems and methods for data handling. Particularly, the present disclosure relates to novel and advantageous systems and methods for viewing, accessing, and monitoring data stored in a data storage system. Tags, metadata, and/or other attributes of data stored in a storage system may be used to define and create particular views of relevant data. In particular, a membership specification may provide inclusion and exclusion directives for determining which files and objects in the storage system to include in the view. A structure specification may provide a structure for organizing and presenting the files and objects in the view. In this way, the data may be presented in the view in a comparative and organized manner, with any desirable structure, despite whether the data is derived from different files systems, object buckets, protocols, programs, applications, or directories. Systems and methods described herein may allow a user to easily identify and view particularly relevant data from, for example, a large storage system storing data from hundreds of files systems. Moreover, the systems and methods described herein may allow for tracking and/or monitoring of particular data attributes.

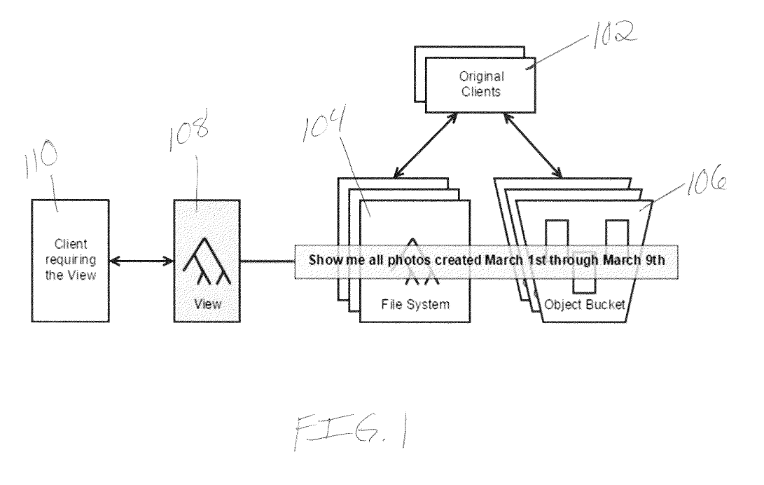

Turning now to FIG. 1, a conceptual diagram of a tag view construction of the present disclosure is shown. In general, one or more users or clients 102 may store files and/or objects in a file system 104 and/or object bucket 106. In some embodiments, the file system 104 and/or object bucket 106 may store thousands, hundreds of thousands, millions, or even billions of documents and/or objects. In other embodiments, more or fewer documents and/or objects may be stored. A user or client 110, which may be the same or a different entity than the storing client 102, may desire to view a portion of the files and/or objects. For example, as shown in FIG. 1, a user 110 may wish to see all photos created between March first and March ninth of a particular year (or alternatively of any year). Systems and methods of the present disclosure may be used to construct a view containing the applicable files and/or objects that correspond with “all photos created between March first and March ninth,” and/or any other parameters designated by the client 110. The view 108 may thus allow the client 110 to quickly and easily view and/or access a particularly defined subset of the file system 104 and/or object bucket 108.

To construct the view 108, systems and methods of the present disclosure may use tags and tag rules. Tags may be labels or categories that are assigned to or associated with particular files and/or objects. One example of a tag may include file extension type. That is, files with the extension .jpeg may receive a particular tag, and files with the extension .tiff may receive a different tag. Other tags may relate to a creation date of the data, author, size, user, path, IP address, export type, and/or any other information about or contained within the data. A tag rule may be a predefined rule to apply or assign a particular tag to files and/or objects having one or more particular attributes. For example, tag rules may be if/then statements, pattern matches, or similar statements. In some embodiments, tag rules may be compared to data as the data enters a file system or object bucket, such that the data may be tagged at ingest. Tags and tag rules may be defined manually by a user, client, or administrator. In some embodiments, tags and tag rules may be defined automatically by a system, or partially automatically based on one or more predefined parameters. In some embodiments, tags and tag rules may relate to metadata. In other embodiments, metadata may be used in addition to, or instead of, tags. That is, in some embodiments, data may be identifiable by the various attributes in its metadata, instead of or in addition to tags associated with the data.

In general, tags may be customizable, such that a user, client, or administrator may tag data based on any desired parameters or qualifications. In this way, users may categorize and label their data in any way they choose, without being bound by particular metadata or other attributes of the data. Tags and tag rules are described in more detail in U.S. patent application entitled Systems and Methods for Data Management Using Zero-Touch Tagging, having Attorney Docket No. 20486.5.0001.US.U2, filed the same day as the present application on Oct. 27, 2017, and having U.S. patent application Ser. No. 15/795,882, the content of which is hereby incorporated by reference herein in its entirety. In general, tags may be used to categorize or group data, such that all data corresponding to a particular tag may be viewed or recalled based on its association with that tag. Tags and tag rules, as well as the use of metadata, may allow data to be easily recalled without the need to sort through several locations or subcategories of a file system or object bucket, for example.

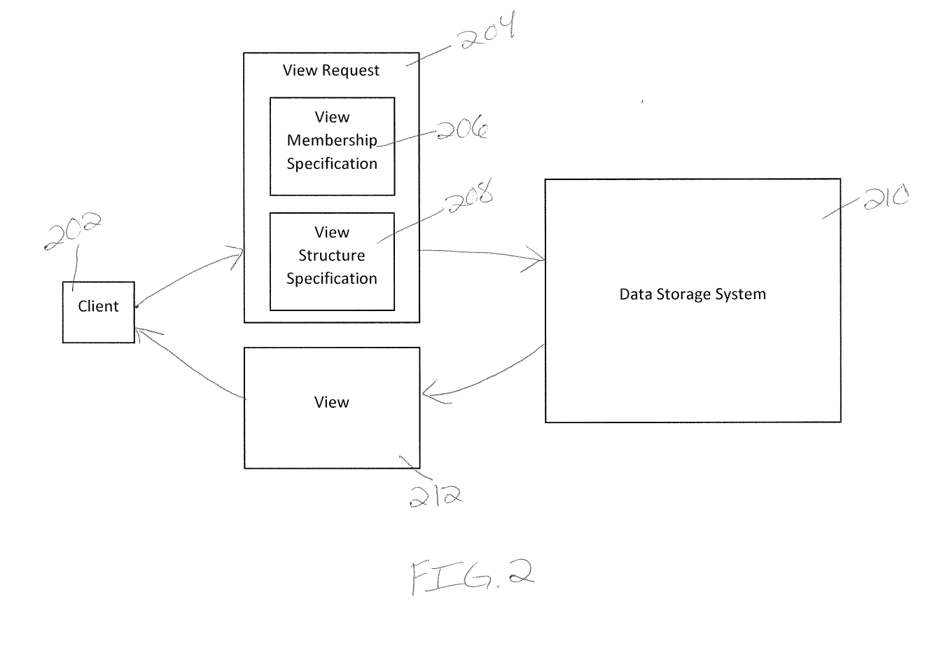

FIG. 2 illustrates the components of a client's or other user's view request. In general, a client 202 or another user, software, or system may submit a view request 204 to a data storage system 210, or another system in communication with a data storage system. In some embodiments, the client 202 or other user may create the view request 204 using an application program interface, user interface, and/or other tools. In some embodiments, the view request 204 may be generated automatically by the data storage system 210 itself, or another system in communication with the data storage system. For example, a view request 204 may be automatically generated in response to a predetermined event or parameter. The view request 204 may include a membership specification 206 and a structure specification 208. In response to the view request 204, the data storage system 210 may return a view 212 to the client 202.

The membership specification 206 may include a number of tags and/or metadata attributes selected by the client 202, to identify the particular data the client wishes to view. For example, the membership specification 206 may have inclusion directives and/or exclusion directives. An inclusion directive may be a set of one or more tags related to data that should be included in the view 212. Any data associated with a tag of the inclusion directive may be provided in the view 212. An exclusion directive may be a set of one or more tags related to data that should be excluded from the view 212. In some embodiments, an exclusion directive may operate to exclude a subset of data within an inclusion directive. Or alternatively, in some embodiments, an inclusion directive may operate to include a subset of data otherwise excluded by an exclusion directive. For example, where data may be tagged with Tag A, Tag B, or both Tags A and B, a user may wish to view only the data having Tag A. The user may then construct a membership specification 206 having an inclusion directive for Tag A, and an exclusion directive for Tag B. Additionally, in some embodiments, inclusion and exclusion directives may relate to metadata attributes. In this way, the client 202 may specify as part of the membership specification 206 that the view 212 should include or exclude data having a particular author, date or time range, file system or object bucket, file name, directory name, size range, owner, or other metadata attribute. While it is to be appreciated that many of these metadata attributes may be associated with one or more tags, the metadata itself may also be used to construct a view 212. As a particular example, the client 202 may wish to view all pictures created after Jan. 1, 2017, and which are smaller than 50 MB. The client 202 may construct a membership specification 206 by selecting for inclusion all data with a “pictures” tag and metadata attribute indicating the data was created after Jan. 1, 2017. The client 202 may further select for exclusion a metadata attribute indicating the data is larger than 50 MB. This membership specification 206 may be compared to the files and/or objects in the data storage system 210 to determine which files and/or objects to provide in the view 212.

As another particular example, a storage system 210 may have files and objects from multiple server clusters, including Server Cluster A and Server Cluster D. The storage system may additionally have data from independent applications, including Application B and Application C. Data in the storage system may include executable, as well as non-executable files. The data may additionally include music files and photo files. In this example, the following tags may be designated and assigned to the various data in the storage system:
Tag A: all data from Cluster A;
Tag B: all data from Application B;
Tag C: all data from Application C;
Tag D: all data from Cluster D;
Tag E: all executable files (exe, dll, pyc, ELF, etc.);
Tag M: all music files (mp3, etc.); and
Tag P: all photo files (jpeg, etc.).

Continuing with the above example, a client 202 or other user may wish to view all files and objects from Cluster A and Application B, but exclude data from other clusters and applications. Additionally, the client 202 may determine that executable files, music files, and photos, are not relevant for this particular view. Accordingly, the client, an administrator, or the system may construct a view request 204 with the following view membership specification 206 parameter:
Include Tag A;
Include Tag B;
Exclude Tag E;
Exclude Tag M; and
Exclude Tag P.

In some embodiments, a view membership specification 206 may be further defined or limited by a tag scope for one or more inclusion or exclusion tags or metadata attributes. For example, where the storage system 210 includes data from more than one file system or object bucket containing data subject to the same tagging structure, the client 202 may wish to limit the included tags to only those from a particular file system or a particular object bucket. Additionally, where a client 202 is only permitted to access particular data in the storage system, a tag scope may be applied to one or more tags to ensure that only permitted data is provided in the view 212. In some embodiments, a tag scope may be applied automatically by the storage system based on the client's username, IP address, or other identifier.

In some embodiments, the view membership specification 206 may have additional parameters, such as where the client wishes to include deleted data, previous versions of data, or data snapshots in a view. In some embodiments, a “delete” tag may be automatically generated and/or assigned to deleted data. Where a client 202 indicates the view 212 should include deleted data, the view may indicate a delete time, user, client, and/or other deletion attributes. In some embodiments, more complex view requests 204 may include rules as part of the membership specification. A rule may relate to the inclusion and/or exclusion of multiple tags or metadata attributes to identify particular files and/or objects. An example of view request 204 having complex rules is described in more detail below.

In addition to a view membership specification 206, a view request 204 may include a view structure specification 208. A structure specification 208 may include parameters, rules, or instructions defining how the view 212 should be organized when presented to the client 202. In general, data in a view 212 may be presented as, or may include, a file system structure and/or an object bucket structure. For example, when data is to be structured or viewed as a file system, such as a NFS, SMB, or HDFS, the data may be provided in accordance with a hierarchical directory structure. The structure specification 208 may define which tags, metadata, and/or other attributes are used, and in what order they are used, to organize the data in the view 212. The tags, metadata, and/or other attributes used to organize the data in the view 212 may include those specified in the membership specification 206. Additionally or alternatively, the tags, metadata, and/or other attributes used to organize the data in the view 212 may include others not specified in the membership specification 206, but which may generally help to present the data in a clear manner. In some embodiments, the client 202 or other user may define the structure specification 208 by specifying the tags, metadata, and/or other attributes to be used, and the order in which they are to be used, to present the view 212. In other embodiments, an administrator may define the structure specification 208. In this other embodiments, all or portions of the structure specification 208 may be determined automatically by the data storage system 210 or another system.

As a particular example, a storage system may have data subject to the following tags:
Tag A: files and objects for Application A;
Tag L: files and objects larger than 50 MB; and
Tag [user]: all files and objects tagged with the user that created them.

A client 202 or other user may wish to view all files and objects with Tag A. A structure specification 208 may help to organize the data provided in the view 212, rather than presenting the view as a flat file system directory. For example, the structure specification may specify that if Tag L is present in any data provided in the Tag A view, the file or object is given the directory name “large.” Similarly, it may be specified that if Tag L is absent in any data provided in the Tag A view, the file or object is given the directory name “small.” Additionally, the structure specification 208 may specify that metadata related to creation date may be used to determine an age in months of each file and object in the view to present the age of the data in the view 212. In some embodiments, a tag corresponding to age in months may be created. Additionally, the structure specification 208 may specify that the Tag [user] should be included in the view 212 in order to show who created each file and object in the view. The structure specification 208 may additionally include file and object names, such that the data in the view 212 is shown with its original name. In some embodiments, a tag corresponding to the file name may be created. Accordingly, a structure specification may be similar to the following:
/TAG-L {“large”,“small”}/“age-”TAG-AGE-MONTHS/“user-”TAG-USER/TAG-ORIG-FILE-NAME.

The above structure specification 208 may thus designate that all Tag A data is presented first in order of size, followed by age, user, and name. In this particular case, for example, the requesting client 202 may be most concerned with the size and age of the data. For example, the client 202 may be reviewing data to determine files and objects to delete. In other embodiments, the tags and metadata designations may be provided in any other suitable order. Moreover, other or different types of tags, metadata, and/or other attributes may be used in the structure specification to organize the data provided in the view 212.

In some embodiments, a structure specification 208 may include an original path tree to show the original directory path of the data in the view 212. In other embodiments, a directory for the view 212 may be structured based on tags, metadata, and/or other attributes of the data. For example, the structure specification 208 may designate:
/directory1{include=TAG-A}/ . . . .
/directory2 {include=TAG-B}/ . . . .

This may allow the view 212 to be structured in a more easily viewable way, or to fit the needs of a particular application, for example.

Similarly, in some embodiments, a structure specification 208 may include an original file/object name for the data in the view 212. In other embodiments, a different file/name may be structured for each file and object in the view 212. For example, with respect to files, it may be desirable to present the data in the view 212 in accordance with its creation user. Moreover, with respect to objects, it may be desirable to display the objects by their object identification. In this way, the structure specification 208 may designate:
“object-id-”OBJECT_UUID # File name is simply the internal object ID TAG-USER.TAG-ORIG-FILE-NAME # Prepend the user name to the file name

In some embodiments, the view 212 may be presented with a standard structure. For example, the structure specification 208 may be a standard specification. Or, where the view request 204 is received without a structure specification 208, a standard view structure may be used.

In some embodiments, a file or object may appear more than once in a view 212. This may occur where the file or object is subject to multiple tags specified in the membership 206 and/or structure specification 208. This may appear to the client 202 in the format they use for multiple paths to identical objects, such as hard links in a network file system.

In some embodiments, data in a view 212 may be structured or presented as a collection of objects, such as using Amazon's S3 protocol or a similar protocol. In this way, a bucket structure may be provided by the structure specification 208. The bucket may be a flat list of objects in some embodiments. However, in other embodiments, the bucket may have a hierarchical structure defined by the structure specification 208, as discussed above.

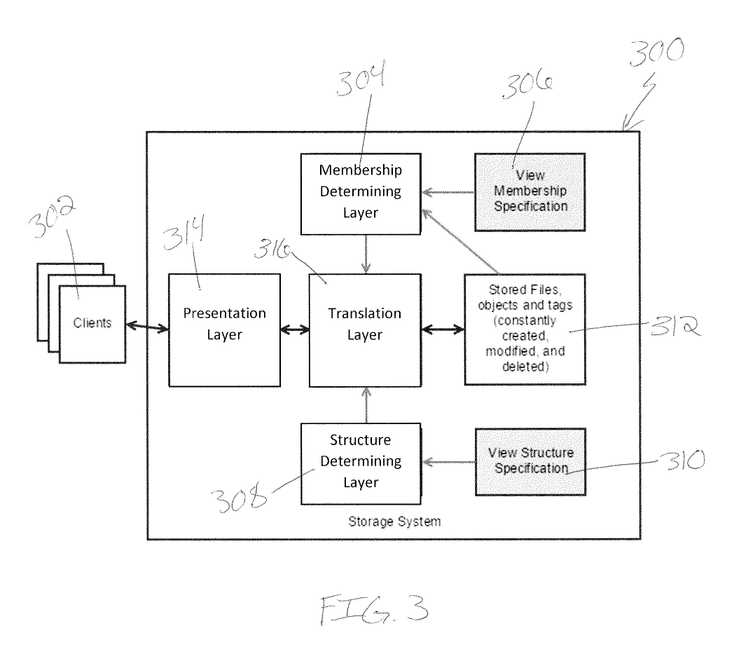

Turning now to FIG. 3, a system for constructing and displaying a tag view is shown. The system may be or include a data storage system 300 in some embodiments. The data storage system 300 or other system may have a membership determining layer 304, a structure determining layer 308, a translation layer 316, and a presentation layer 314. The storage system 300 or other system may be configured to receive view requests from, and present views to, clients 302 or other users.

The data storage system 300 may store files, object, and/or tags 312. Files and/or objects may be stored as part of one or more files systems and/or one or more object buckets. The files and/or objects may include readable and/or writable data. That is, the data storage system 300 may receive input and output (I/O) requests from one or more clients, users, or administrators. In addition to files and/or objects, the data storage system 300 may store tags in, for example, a tag database. As described above, tags may be identifiers for categorizing or labeling files and/or objects. Each tag identified by a user, administrator, client, and/or system may be stored in the data storage system 300. In some embodiments, tag rules may additionally be stored in the storage system 300. That is, user or system defined statements indicating when a tag should be applied to a particular file or object may be stored within the data storage system 300. In some embodiments, files and/or objects may be stored together with any tags that have been associated with, or appended to, the data. In other embodiments, however, the storage system 300 may store associations between data and tags in, for example, a mapping database. The associations may identify which tags are associated with which files and/or objects in the system 300.

The data storage system 300 may have random access storage, flash storage, and/or other suitable storage types. The data storage system 300 may include more than one database in some embodiments. Moreover, the data storage system 300 may include local and/or remote databases. In some embodiments, the data storage system 300 may include cloud storage drives. In some embodiments, the data storage system 300 may relate to a particular client or user. In some embodiments, the data storage system 300 may be provided or owned by a particular client or user. However, in other embodiments, the data storage may store data related to more than one client or user. In some embodiments, data may be stored in the data storage system 300 in accordance with the systems and methods described in U.S. patent application entitled Systems and Methods for Random to Sequential Storage Mapping, having Attorney Docket no. 20486.7.0003.US.U2, filed the same day as the present application on Oct. 27, 2017, and having U.S. patent application Ser. No. 15/796,234, the content of which is hereby incorporated by reference herein in its entirety.

The data storage system 300 may include hardware, software, and in some embodiments both hardware and software. For example, in some embodiments, the data storage system 300 may include hardware, such as for example one or more data storage drives, a controller, a processor, hardware circuitry, and/or other hardware components described herein. Hardware circuitry may include receiving hardware circuitry, data accessing hardware circuitry, sending hardware circuitry, or other hardware circuitry. The controller, processer, hardware circuitry, and/or other hardware components may be configured to run or operate one or more software programs or applications. In some embodiments, the data storage system 300 may be part of a broader system, which may perform or execute the process operations described herein. Moreover, in some embodiments, components of the data storage system 300, or of any system of the present disclosure, may be described as a layers, components, modules, or elements of a system. Such layers, components, modules, or elements may include hardware and/or software, as described above, for performing the process operations described herein.

With continued reference to FIG. 3, the membership determining layer 304 may be configured to determine data to be included in a view in response to a view request. The membership determining layer 304 may determine the files and/or objects to present in the view based on a membership specification 306. As described above, the membership specification 306 may be included with the view request. The membership specification 306 may be defined by the client 302, an administrator, another user, the storage system, or another system. The membership determining layer 304 may compare the membership specification 316 to the stored data and tags 312 to determine which files and/or objects to include in the view to be presented to the client 302. In some embodiments, the membership determining layer 304 may compare the membership specification 306 to associations between tags and data to determine which files and/or objects to include in the view. For example, if the membership specification 306 indicates that all files and objects associated with Tag A should be included in the view, the membership determining layer 304 may examine the data and/or tag-data associations to determine which files and/or objects are associated with Tag A, and should thus be included in the view. The membership determining layer 304 may apply both inclusion directives and exclusion directives, as well as any tag scopes, and other parameters of the membership specification 306 to determine which files and/or objects of the storage system 300 should be included in the view.

The structure determining layer 308 may identify and determine the structure of the view to be provided to the client 302 based on a view structure specification 310. As described above, the structure specification 310 may be defined by the client 302, an administrator, another user, the storage system 300, or another system. The structure determining layer 308 may organize the data to be included in the view in accordance with the structure specification 310. For example, if the structure specification 310 indicates that the data in the view should be provided according to particular tag and/or metadata information in a particular order, the structure determining layer 308 may organize the data in that order.

The presentation layer 314 may be configured to present the view to the client 302 or other user. The view may be presented on any suitable interface or system, including for example, NFS, SMB, S3, HDFS, TFTP, or other suitable file and object interfaces and protocols. The view may be provided with various permissions.

For example, in some embodiments, the view may be provided as a read-only view. In a read-only view, the client 302 may be permitted to read data and directories in the view, but may be prohibited from modifying or deleting the data. A read-only view may be used for discovery, research, forensics, distribution, or dissemination of information, for example.

Another type of view may be a read-only data, read-write structure view. In a read-only data, read-write structure view, the client 302 may be permitted to modify, delete, move, and rename data within the view. However, the underlying data in the data storage system may be protected, such that the client's modifications to the view will not affect the underlying data. This type of view may be used for discovery or research, for example.

Another type of view may be a read-write data, read-only structure view. In this type of view, the client 302 may be permitted to modify, delete, move, and rename the underlying data in the storage system. However, the client 302 may be prohibited from modifying the view itself. This type of view may be used where one application is creating the data in an NFS export, for example, and another application is processing the data and perhaps changing it from an S3 application, for example.

Another type of view may be a read-write view. In a read-write view, the client 302 may be permitted to read and modify data in both the view and the underlying storage system 300. However, while the client may delete data from the view, the client 302 may be prohibited from deleting the underlying data in the storage system 300. In some embodiments, a filter or other mechanism may be used to ensure that data deleted from the view remains excluded from the view or future iterations of the view, even though the data still exists in the underlying storage system 300.

Another type of view may be a read-write-delete view. This type of view may provide the most permissions, wherein a client 302 may read, modify, and delete data from both the view and the underlying data storage system 300. This may be an administrative view in some embodiments. This type of view may be used to find and delete old or unneeded data from the system, for example.

In some embodiments, the view may be presented as a cloud view. For a cloud view, data needed to present the view (but not necessarily the underlying data itself) may be copied to cloud storage, and presented to a client 302, which may be a remote client. This may allow clients and other users to access particular portions of data within the storage system 300 remotely without the need to provide for complete remote access or access to all data within the storage system.

With continued reference to FIG. 3, the translation layer 316 may generally translate data and operations between the data presented in the view and the corresponding data 312 stored in the data storage system 300. For example, the translation layer 316 may map the data provided in the view to the stored data 312, such as where particular file names or directories are created for the view. Additionally, the translation layer 316 may be configured to act on the stored data 312 in response to operations performed by a client 302 with respect to the view. Similarly, if files and/or objects are updated or modified in the stored data 312, the translation layer 316 may update or modify the view for corresponding files and/or objects. In this way, the translation layer 316 may help to maintain dynamic tag views. Likewise, as the underlying data 312 changes, the translation layer 316 may update corresponding views. In some embodiments, these updates may be performed in real-time or substantially real-time.

In some embodiments, the translation layer 316 and/or presentation layer 314 may be configured to map or replace particular file attributes in a view. For example, it may be desirable to anonymize names or other personal information in a view. Similarly, it may be desirable to modify or obscure proprietary information or other sensitive information. This may be specified by a user via a structure specification, for example, or another user input, or may be performed by the system automatically or partially automatically based on one or more predefined parameters or settings. Similarly, it may be desirable to provide different access control lists or permissions with respect to the view data, as compared with the underlying data.

Each of the membership determining layer 304, structure determining layer 308, translation layer 316, and presentation layer 314 may include only hardware, only software, or a combination of hardware and software. For example, in some embodiments, the membership determining layer 304, structure determining layer 308, translation layer 316, and/or presentation layer 314 may include hardware, such as for example a controller, processor, hardware circuitry, and/or other hardware components described herein. Hardware circuitry may include receiving hardware circuitry, data accessing hardware circuitry, sending hardware circuitry, or other hardware circuitry. The membership determining layer 304 may have membership determining hardware circuitry, for example. The structure determining layer 308 may have structure determining hardware circuitry. The translation layer 316 may have data translation hardware circuitry. The presentation layer 314 may have view presentation hardware circuitry. The various controllers, processers, hardware circuitry, and/or other hardware components of the membership determining layer 304, structure determining layer 308, translation layer 314, and presentation layer 314 may be configured to run or operate one or more software programs or applications for receiving user commands, parsing and converting user commands, executing user commands, analyzing user commands, and updating dictionary entries. Moreover, in some embodiments, any of the membership determining layer 304, structure determining layer 308, translation layer 316, and presentation layer 314 may be described as a component, application, module, or element of a system. Such component, application, module, or element may include hardware and/or software, as described above, for performing the above-described operations.

Additionally, the storage system 300 or any system of the present disclosure may generally include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, the system 300 or any portion thereof may be a minicomputer, mainframe computer, personal computer (e.g., desktop or laptop), tablet computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. The storage system 300 or any system of the present disclosure may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of the storage system 300 or any system of the present disclosure may include, in addition to or alternative to the data storage devices, one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. The system 100 may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system 100 may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

The storage system 300 or any system of the present disclosure may also generally include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, etc.) using any of a variety of commercially available bus architectures.

One or more programs or applications, such as a web browser, application program interface (API), and/or other executable applications, may be stored in one or more of the system data storage devices. For example, membership determining layer 304, structure determining layer 308, translation layer 316, and presentation layer 314 may be or include programs or applications stored in, and configured to run or execute on, the storage system 300 or another system of the present disclosure. Generally, programs may include routines, methods, data structures, other software components, etc., that perform particular tasks or implement particular abstract data types. Programs or applications may be loaded in part or in whole into a main memory or processor during execution by the processor. One or more processors or controllers may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

The storage system 300 or any system of the present disclosure may operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The storage system 300 or any system of the present disclosure may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices. In some embodiments, some or all of the components, applications, or programs of the system 300 or any system of the present disclosure may be provided as cloud-based components, or may be otherwise provided by, executed on, or supported by, a cloud system.

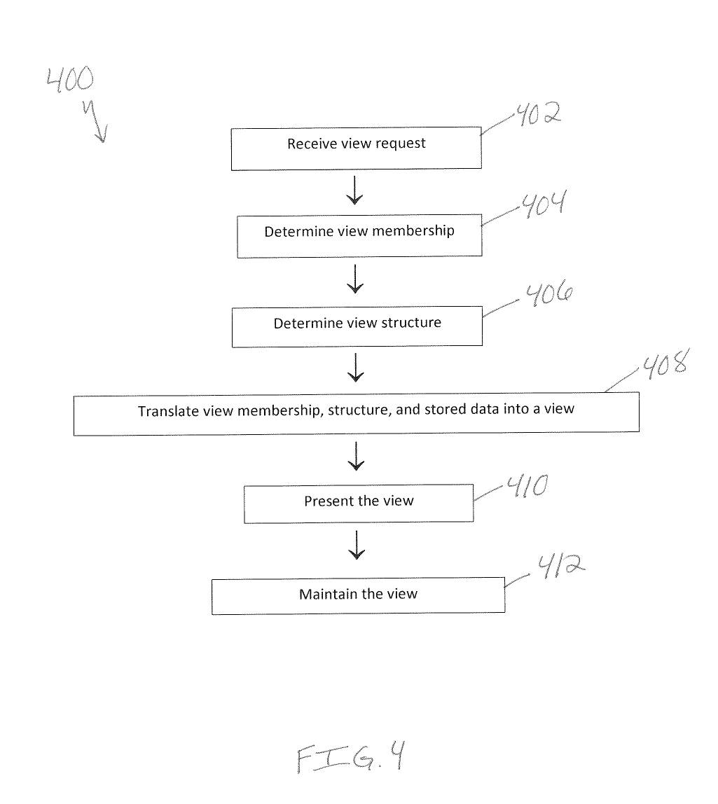

Turning now to FIG. 4, a method 400 of providing a view of the present disclosure is shown. The method 400 may be performable on a system described herein, such as the system 300 described with respect to FIG. 3. The method 400 may include the steps of receiving a view request 402; determining view membership 404; determining view structure 406; translating the view membership, structure, and stored data into a dynamic view 410; presenting the view 410; and maintaining the view 412. In other embodiments, the method may include other or additional steps.

Receiving a view request 402 may include receiving a request from a client, administrator, or other user, system, or software. The view request may be received in any suitable format. In some embodiments, the view request may be generated internally in a system of the present disclosure, or via another system. As described above, the view request may include a membership specification defining the data files and objects requested, and a structure specification defining the structure of the requested view. In some embodiments, a view request may be a request or directive to update a previously defined view. The request may be received via a request receiving module or any other suitable system component. However, it is to be appreciated that, in some embodiments, a view may be generated without first receiving a request. For example, a view may be generated automatically based on predefined parameters.

As described above, view membership may be determined 404 using a membership specification provided as part of the view request, or otherwise provided or defined by a user, system, or application. The view membership may be determined by comparing data within the data storage system to the membership specification. For example, tags, files, objects, and/or tag-data associations may be compared to the membership specification to determine view membership. Both inclusion directives and exclusion directives may be compared to the data in the storage system to determine view membership. Additionally, any other parameters of the membership specification, such as but not limited to tag scopes, may be used to determine view membership.

As additionally described above, view structure may be determined 406 using a structure specification provided as part of the view request, or otherwise provided or defined by a user, system, or application. The structure specification may define tags, metadata, and/or other attributes by which the view is to be organized. Determining the view structure may include comparing the structure specification to tags, metadata, and/or other attributes for the data in order to organize, categorize, and generally structure the data for the view.

Translating the view membership, structure, and stored data into a view 408 may include laying out the data defined by the membership specification in accordance with the structure defined by the structure specification. Additionally, translating the information into a view may include mapping the information included in the view to the data storage system where the data is stored. For example, the data may be structured differently in the view, according to the structure specification, than it is in the storage system. Additionally, file names, object names, directory paths, and/or other information or attributes may be defined differently in the view than in the underlying storage system. These differences and changes between the view and underlying data may be mapped. The mapping may allow for any changes made to data in the view to affect data in the storage system, where permitted. Additionally, the mapping may allow for any changes made to the data in the storage system to affect data in the view.

Presenting the view 410 may include providing the view to the client, administrator, user, system, or application that requested the view. In some embodiments, presenting the view may include displaying the information at, for example, an application program interface, program interface, or other user interface. The view may be presented to be compatible with any suitable programming, system, and/or protocol. Moreover, as described above, in some embodiments, the view may be presented with any suitable permissions. The permissions may relate to the purpose for the particular view. In some embodiments, the permissions may be defined automatically, or predefined, based on the identification of the requesting source. In other embodiments, the permissions may be defined by the requesting source, or by another entity, such as an administrator.

Maintaining the view 412 may include updating the view as needed. For example, as writes, modifications, or deletions are made to the underlying data on the data storage system that is represented in the view, the view may be updated to reflect the changes. In some embodiments, the view may be updated dynamically or automatically upon changes made to the underlying data. In some embodiments, the view may be updated periodically, based on any suitable intervals, or based on upon an update request or directive.

In some embodiments, the systems and methods described herein may be used to track statistics, track quotas, provide alerts, and/or provide reporting with respect to data stored in the storage system. For example, in some embodiments, a system of the present disclosure may have a tag statistics engine or layer. The tag statistics engine may track information with respect to tags, metadata, and/or other attributes of data in the storage system. The tag statistics engine may track or log this information by monitoring operations performed with respect to data in the system. For example, the tag statistics engine may monitor data writes, deletions, and migrations performed in the data storage system. The tag statistics engine may track a variety of different statistics related to tags, metadata, particular types of files and/or objects, or other attributes of data. For example, the tag statistics engine may track the following statistics for one or more tags:
Amount or percent of space in the system used
Amount or percent of a predefined quota used
Growth rate of storage
Number of I/O operations
Number of files
Number of objects
I/O operations per second (IOPS)
Storage usage per day

In some embodiments, the tag statistics engine may monitor any of the above information and/or other tag, metadata, or other data information on a continuous basis. In other embodiments, the tag statistics engine may monitor the information on a periodic basis, such as hourly, daily, weekly, or on another basis. In other embodiments, the tag statistics engine may monitor the information upon receiving a request. The tag statistics engine may be configured to provide the above statistics information and/or other statistics information about tags, metadata, and/or other data attributes to a user without the need to construct an entire view of the underlying data. In this way, a user or administrator may view and monitor information about data in the storage system without the need to request various complex views or access the underlying data. Moreover, the tag statistics engine may be configured to provide alerts. For example, if one or more predefined thresholds is neared, reached, or surpassed, the tag statistics engine may send an alert to a user. In some embodiments, the tag statistics engine may be configured to monitor and enforce hard quotas. For example, if a storage quote is neared, reached, or exceeded, the tag statistics engine may be configured to stop new data writes in some embodiments. In some embodiments, the tag statistics engine may be configured to provide reports. For example, the tag statistics engine may provide periodic reports with monitored statistics data.

The following is a particular example of how systems and methods of the present disclosure may be used to provide a complex view of particular data in a data storage system. A large organization or storage system may store data in hundreds of file systems, for example. File systems Project X1, Project X2, and Project X3 may relate to sensitive or proprietary data, or data with read/write restrictions. A user may wish to know if any changes have been made to large video files stored in the data storage system within the past week. The user may further want to know where those video files are stored, and who made the changes. One version of the membership specification may include the following inclusion and exclusion directives:
Include all file systems
Exclude file systems Project X1, Project X2, and Project X3
Include anything tagged “video”
Exclude anything tagged “project_x_output”
Include files with modification time <1 week ago
Include files with size >100 MB

In some embodiments, the user may select or define each of the above inclusion and exclusion directives. However, in other embodiments, some or all of the directives may be generated automatically by the system. For example, based on the user's identification, it may be determined that the user does not have access to Projects X1, X2, or X3. Accordingly, the system may automatically input exclusion directives for those file systems and for data tagged as related to those file systems.

To view the data, the user may wish to view the user identifier of the user who wrote or modified the file, the file system name for each file, and the original path of the file within the system. Thus, a structure specification for the view may, for example, include the following:
/TAG/USERID-LASTMOD/FILESYSTEM/ORIGINAL-PATH
   This view may allow the user to determine if there are large video files improperly stored in a directory path for a wrong project or file system, for example.

Continuing with this particular example, if the following large video files have been recently created or modified in the system, only two of them will appear in the above requested view:
In file system project5, the file /my-videos/kittens.mov written by user “alice.”
In file system project5, the file /my-videos/Project X1-part1.mp4 written by user “alice,” but tagged as project_x_output.
In file system project10, the file files/project/terminator-2.mp4 written by user “bob.”
In file systems ProjectX1, X2, and X3, alice and bob write several video files.

In the resulting view, in accordance with the membership specification, only the kittens.mov video and the terminator-2.mp4 video would be shown. The other video files listed above would be excluded as a result of the exclusion directives related to Projects X1, X2, and X3. Additionally, any videos modified or created more than a week ago, and any videos smaller than 100 MB would not be included in the view. In this way, a view may be created to show the particular data that the user wishes to see, while filtering out unrelated or unnecessary data.

The systems and methods of the present disclosure may allow clients, administrators, or other users to easily and efficiently sort through data in order to focus on the particular files or objects relevant to the user. By using tags, metadata, and/or other attributes of the data stored in a storage system, the systems and methods of the present disclosure provide for relatively efficient identification of particular files and objects in the storage system. The data in the view may be pulled from a plurality of file systems, object buckets, structure orientations, protocols, and applications. Moreover, the relevant files and object may be presented to the user with any suitable structure, naming scheme, categorization, and naming hierarchy. In this way, the relevant data from a variety of different sources and outputs within the storage system may be viewable together, in an easily readable and comparative structure. Systems and methods of the present disclosure may be particularly useful or beneficial in relatively large storage systems storing data for hundreds or thousands of different file systems, for example. Below are some examples of particular uses in which the systems and methods of the present disclosure may be particularly beneficial.

In one particular example, a user may create an NFS or SMB view of all data from a particular team that has not been accessed in three years. The data may be organized in the view by identification of the user who created the data, then by original data structure of the data. The user may use this view to determine if the data can be deleted.

In another particular example, a user may create an S3 bucket view containing all NFS files that have the extension “myapp” and are created by servers in Cluster X. The user may allow access to the bucket view from an analytics application which automatically can see new files placed in the file system as its own objects.

In another particular example, a user may create a read-only NFS or SMB view of all data created or modified by a particular group of users between Jan. 1, 2014, and Dec. 31, 2014. The user may allow a forensics, legal, or due diligence project team access to this view.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A view request for viewing a subset of data stored on a data storage system, the view request comprising:
a membership specification defining the subset of data to be included in the view, the membership specification comprising:
an inclusion directive defining data to be included in the view; and
a structure specification defining a structure by which the view is to be provided.

2. The view request of claim 1, wherein the structure comprises a hierarchical structure.

3. The view request of claim 1, wherein the membership specification further comprises an exclusion directive defining data to be excluded from the view.

4. The view request of claim 1, wherein the data stored on the data storage system is associated with a plurality of tags, and the inclusion directive comprises a tag associated with the subset of data.

5. The view request of claim 4, wherein the membership specification further comprises an exclusion directive defining data to be excluded from the view.

6. The view request of claim 5, wherein the exclusion directive comprises a tag associated with the subset of data.

7. The view request of claim 4, wherein the inclusion directive further comprises a tag scope limiting the subset of data.

8. The view request of claim 1, wherein the data stored on the data storage system comprises metadata, and the inclusion directive comprises a metadata attribute associated with the subset of data.

9. A method of providing a data view, the method comprising:
receiving a view request for a subset of data in a data storage system, the view request comprising:
a membership specification defining the subset of data to be included in the view; and
a structure specification defining a structure by which the view is to be provided;
identifying the subset of data by comparing the membership specification to data in the data storage system;
identifying the structure of the view;
organizing the subset of data in accordance with the structure to construct the view such that the view is mapped to the data storage system; and
presenting the view.

10. The method of claim 9, wherein the membership specification comprises an inclusion directive defining data to be included in the view, and an exclusion directive defining data to be excluded from the view.

11. The method of claim 10, wherein the data stored on the data storage system is associated with a plurality of tags, and the inclusion directive comprises a tag associated with the subset of data.

12. The method of claim 11, wherein the exclusion directive comprises a tag associated with the subset of data.

13. The method of claim 12, wherein the inclusion directive further comprises a tag scope limiting the subset of data.

14. The method of claim 9, further comprising updating the view when changes are made to the subset of data.

15. The method of claim 11, wherein at least one statistic is maintained for the tag associated with the subset of data.

16. The method of claim 15, wherein presenting the view comprises presenting the statistic.

17. A data handling system, comprising:
a data storage device storing data as non-transitory computer readable media;
a membership determining layer for determining a subset of the data identified in a view request;
a structure determining layer for determining an organization structure for the subset of the data, as identified in the view request;
a translation layer for mapping the view to the subset of the data; and
a presentation layer for presenting the view of the subset of the data according to the structure.

18. The data handling system of claim 17, wherein the data storage device further stores a plurality of tags associated with the data, and wherein the subset of the data is defined by one or more tags.

19. The data handling system of claim 18, further comprising a statistics engine tracking a statistic for at least one of the one or more tags defining the subset of data.

20. The data handling system of claim 19, wherein the statistic comprises at least one storage space used, growth rate of storage, I/O operations, objects, I/O operations per second, and storage space used per day.
